(19) United States
(12) Patent Application Publication
(10) Pub. No.: US 2007/0183957 A1
(43) Pub. Date: Aug. 9, 2007

(54) Reactor and process

(75) Inventors: Antony John Warr, Chester (GB); Lee David Proctor, Denbighshire (GB)

Correspondence Address: KNOBBE MARTENS OLSON & BEAR LLP, 2040 MAIN STREET, FOURTEENTH FLOOR, IRVINE, CA, 92614, US

(73) Assignee: PHOENIX CHEMICALS LIMITED, WIRRAL (GB)

(21) Appl. No.: 10/588,562

(22) PCT Filed: Oct. 18, 2004
(86) PCT No.: PCT/GB04/04398

§ 371 Date: Sep. 29, 2006

(30) Foreign Application Priority Data
Feb. 7, 2004 (GB) 0402629.0

(51) Int. Cl. C01B 21/00

(52) U.S. Cl. 423/413

(57) ABSTRACT

The invention relates to a process for the production of chloramine comprising supplying a first reagent stream comprising chlorine gas and a second reagent stream comprising ammonia gas to a reaction zone maintained at a temperature of less than 275° C. and configured to allow expansion of the first and second reagent streams in the reaction zone to an extent sufficient to generate chloramine as a gas and ammonium chloride as a free falling solid. The invention also provides a chemical reactor suitable fur operating this process.

The present invention relates to a process for the preparation of chloramine, and to a chemical reactor configured for operating the inventive process.

Chloramine is a commercially important chemical that is widely used, particularly in connection with water treatment and disinfection. It is commonly generated by means of the straightforward chemical reaction:
2NH₃+Cl₂→NH₂Cl+NH₄Cl

Chloramine is also useful as a reagent in the production of hydrazines, by reaction with amine substrates:
R₂HN+NH₂Cl→R₂N—NH₂+HCl

Hydrazines are themselves useful in many commercial applications, for instance as reagents in the preparation of pharmaceuticals and agrochemicals, and in polymer processing. In the past much interest was shown in these reactions by the aerospace industry, in particular because of the use of certain hydrazines as rocket fuels. More recently, chloramines have become of significant interest as reagents in the production of various pharmaceutical intermediates.

It has long been recognised that the production of chloramine from ammonia is desirably carried out under anhydrous conditions. U.S. Pat. No. 2,837,409 discloses a process for preparing substantially anhydrous chloramine by conducting the reaction between ammonia and chlorine in the gas phase with a molar excess of ammonia in the reaction mixture. However, conducting this reaction in the gaseous phase leads to its own problems, in particular because of the generation of solid ammonium chloride (a material which sublimes at around 350° C.) in the reactor.

Unclassified Report No. SAMSO-TR-79-42, entitled Studies of the Production of Chloramine in the Gas Phase, of Badcock et al, dated 1 Jun. 1979 presents detailed studies of the continuous gas phase generation of chloramine from ammonia and chlorine, and discusses the problems caused by solid ammonium chloride plugging the reactor. In another Report, SAMSO-TR-79-41, also dated 1 Jun. 1979, two of the authors present findings on The Production of Chloramine by Liquid Phase Injection of Ammonia and Chlorine, and observe a change in the physical nature of the solid ammonium chloride generated by the reaction, making the material easier to dislodge from the reactor.

U.S. Pat. No. 3,488,164 (and its United Kingdom equivalent GB-B-1149836) discloses a process for the production of chloramine in the gas phase with the aid of an inert diluent gas. Removal of solid ammonium chloride is effected with the aid of a glass wool plug filter, through which the gaseous chloramine product must also flow. Blocking of the plug is a seemingly inevitable problem with this arrangement, although the inventors are silent as to this occurrence, and its consequences. A somewhat similar disclosure is made by Prakash et al in Allgemeine und Praktische Chemie 21-4-1970, pp 123-124.

In U.S. Pat. No. 4,038,372, the problem of reactor plugging is addressed by purging the area downstream of the reactor with an inert gas, or with ammonia, and then filtering the purge stream. Experience has shown, however, that ammonium chloride tends to sinter onto those surfaces, and can prove resistant to such attempts to remove it.

Despite these developments, the commercial scale production of chloramine, and its subsequent use as a reagent in the preparation of hydrazines, continued to be hampered by the deposition of ammonium chloride in the reactor. Increasingly elaborate solutions were adopted, for example as reported by Lewis et al in a report entitled Feasibility of a Modified Chloramine Process, under No. SAMSO-TR-T8-29, which discloses the use of electrostatic and thermal precipitators, in conjunction with reactor wall vibrators, to address the ammonium chloride problem.

is an object of the invention to provide an improved process for the production of chloramine, in particular a process that can be operated continuously, and to provide a chemical reactor suitable for operating the process. It is a further object of the invention to provide such a process which can be operated successfully without filtration, and for prolonged periods.

According to the present invention, there is provided a process for the production of chloramine comprising supplying a first stream comprising chlorine gas and a second stream comprising ammonia gas to a reaction zone maintained at a temperature of less than 275° C. and configured to allow expansion of the first and second streams in the reaction zone to an extent sufficient to generate chloramine as a gas and ammonium chloride as a free falling solid.

Preferably, the reaction between chlorine and ammonia takes place in a laminar flow region of the reaction zone. More preferably, the laminar flow region is bounded by a Reynolds Number of not more than 2000.

A key advantage of the process of the invention lies in the discovery that ammonium chloride is easier to remove from the reaction zone if it is formed (by the reaction of ammonia and chlorine) at least mostly away from any wall of the reaction zone. Thus, in one of its aspects the invention provides a process for producing chloramine comprising providing a first reagent stream comprising ammonia gas and a second reagent stream comprising chlorine gas; contacting the first reagent stream with the second reagent stream in a reaction zone maintained at a temperature below 275° C. to generate chloramine gas and ammonium chloride as a solid which falls downwardly in the reaction zone as it is generated, the reaction zone being configured such that at least about 90% of the generated ammonium chloride is formed at least about 10 mm away from any wall of the reaction zone. Preferably, at least 95% of the generated ammonium chloride is formed at least about 10 mm away from any wall of the reaction zone. Also preferably, at least 90%, more preferably 95%, of the generated ammonium chloride is formed at least about 15 mm, more preferably at least about 20 mm, from any wall of the reaction zone.

Another advantage of the invention is that the process can be operated without filtration. This means that prolonged operation, preferably on a continuous basis, is possible with the process of the invention.

The reaction zone may be bounded towards its top by a reagent supply zone, from which the first and second reagent streams are supplied to the reaction zone, and may be bounded towards its bottom by a solids recovery zone, from which solid ammonium chloride may be recovered, or collected. Gaseous chloramine product should also be recoverable from the reaction zone, preferably by means of a chloramine recovery line located above the reaction zone. The reaction zone itself may be bounded by side walls (or a continuous side wall) extending between the supply region and the solids recovery zone. The side wall(s) bounding the reaction zone circumscribe an expansion region into which gaseous chlorine and ammonia from the reagent streams may expand before reacting to form chloramine and ammonium chloride. Preferably, the expansion region is configured to provide a laminar flow region for the reagents. The expansion region is preferably of a size sufficient to allow at least 60%, preferably at least 85%, more preferably 93%, and most preferably at least 98% (for instance 99% or more) of the supplied chlorine gas to react such that the solid ammonium chloride thereby generated avoids contact with the side wall(s) of the reaction zone as it is formed.

Also provided in accordance with the invention is a chemical reactor suitable for the production of chloramine, the reactor comprising a reagent supply zone above a solids recovery zone, and with a reaction zone bounded by side walls (or one continuous side wall) extending between the reagent supply zone and the solids recovery zone, the reagent supply zone comprising means for supplying, separately, chlorine gas and ammonia gas to the reaction zone, at least one of the supply means being configured to direct reagent gas into a laminar flow region of the reaction zone, the reactor further comprising means for recovering product chloramine gas therefrom.

In the chemical reactor of the invention may be arranged to introduce chlorine gas into the reaction zone, optionally in combination with an inert diluent gas such as nitrogen. An injection nozzle may be used for supplying the gas. In this case the inert diluent gas may be introduced to the reaction zone through a diluent gas injection nozzle adjacent the chlorine gas injection nozzle. The diluent gas injection nozzle and toe chlorine gas injection nozzle may be substantially concentric, with the diluent gas injection nozzle forming a sleeve around the chlorine gas injection nozzle. The chlorine gas injection nozzle may if desired project slightly further than the diluent gas injection nozzle towards the reaction zone.

The solids recovery region of the reactor may comprise a gravitational settler, or other form of solids recovery apparatus, such as a cyclone, for recovery of ammonium chloride.

According to the present invention, there is provided a process for the production of chloramine comprising providing a reaction zone maintained under conditions effective for chlorination of ammonia, and at a temperature of less than 275° C., the reaction zone having a first inlet for the injection of chlorine gas to the reaction zone along a first injection axis, a second inlet for the injection of ammonia gas to the reaction zone along a second injection axis, and an outlet for recovery of gaseous chloramine product, the reaction zone comprising an expansion region projecting radially with respect to at least one injection axis to an extent sufficient to allow expansion within the reaction zone of each injected gas such that mixing and reaction of the injected gases on expansion generates gaseous chloramine, and ammonium chloride as a free flowing powder in the reaction zone, the process including recovering the gaseous chloramine via the outlet.

The process of the invention derives from the recognition that the physical nature of solid ammonium chloride generated in the reaction can be altered, and to some extent controlled, as a function of the physical characteristics of the reaction zone, and/or as a function of the reaction temperature. Much prior art has concentrated on maintaining the temperature in the reaction zone at a sufficiently high level (i.e. well above 275° C.) to maintain ammonium chloride in a sublimated state in the reaction zone. Although many prior art processes teach subsequent cooling of the reaction product mixture, after reaction has taken place, it has generally been accepted that the reaction itself should take place at a high temperature (usually above 275° C.). However, quite apart from the cost and inconvenience of maintaining the reaction zone temperature at such levels, such approaches merely-delay the problem of how to remove the bulk of the ammonium chloride from the chloramine product stream. Almost inevitably (in any practical, commercial sense), this must mean cooling the combined stream at some stage and thus dealing with the problem of solid ammonium chloride generation downstream.

It has now been discovered that the physical form of the solid ammonium chloride generated in the reaction is controllable to some extent with respect to the reaction zone temperature. In particular, relatively low reaction zone temperatures tend to facilitate the generation of ammonium chloride as a free flowing powder, which tends not to stick to the reactor walls, particularly if the reactor is configured substantially to minimise contact between the reactor walls and ammonium chloride as it is formed. Thus, in the process of the invention, the temperature of the reaction zone is maintained below 275° C., preferably below 250° C., more preferably below 200° C., still more preferably below 150° C. and most preferably below 100° C. In one particularly preferred process according to the invention the temperature of the reaction zone is maintained below about 50° C., or the reaction may simply be conducted at ambient temperature. It will be understood by those skilled in the art that the generation of chloramine from ammonia and chlorine is an exothermic reaction, and that hot spots inside the reaction zone are likely to arise as a result. The preferred temperatures indicated herein represent bulk conditions inside the reaction zone.

Whilst the temperature inside the reaction zone has been found to be important in the process of the invention, it has also been discovered that the size and/or configuration of the reaction zone can play an important role in this respect. In particular, the generation of solid ammonium chloride as a free flowing powder is thought to be facilitated by conducting the ammonium chloride-generating reaction in a laminar flow region, preferably bounded by a Reynolds Number of less than 2000, of the reaction zone. It is thought that the generation of ammonium chloride as a free flowing powder is facilitated by providing an expansion region in the reaction zone. When chlorine gas is introduced into the reaction zone along an injection axis, the expansion region preferably projects radially with respect to said injection axis.

The provision of an expansion region which projects radially with respect to the chlorine injection axis is particularly advantageous because the distance between the chlorine gas injection point and the boundary of the reaction zone is thereby maximised, and a laminar flow region is provided. The process of the invention allows the reaction between chlorine and ammonia to take place in the laminar flow expansion region of the reaction zone and for solid ammonium chloride thereby to be generated as a free flowing powder which “snows” out of the reaction zone.

Preferably, the process of the invention is operated as a continuous process, in which case the invention provides a continuous process for the production of chloramine comprising continuously supplying a first stream comprising chlorine gas and a second stream comprising ammonia gas to a reaction zone maintained at a temperature of less than 275° C. and configured to allow expansion of the first and second streams in the reaction zone to an extent sufficient to generate chloramine as a gas and ammonium chloride as a free falling solid, and continuously recovering solid ammonium chloride and gaseous chloramine from the reaction zone.

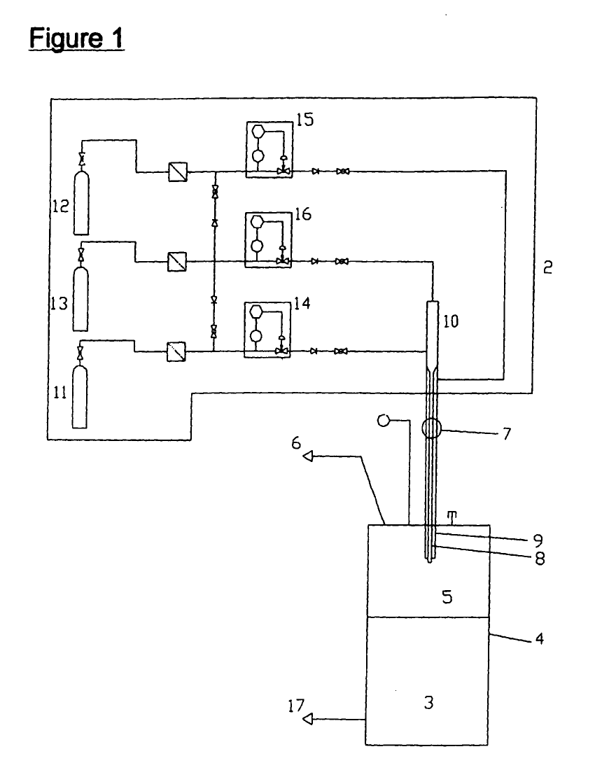

The reactor of the invention is illustrated in the FIG. 1, which shows a flow diagram of a chloramine reactor constructed and arranged to operate in accordance with the process of the invention.

Referring to FIG. 1, there is shown chemical reactor 1 comprising reagent supply zone 2 above solids recovery zone 3, reactor 1 comprising continuous side wall 4 extending between reagent supply zone 2 and solids recovery zone 3 and circumscribing reaction zone 5. Chloramine gas is recovered from the reactor in line 6.

Reagent supply zone 2 comprises the top part of reactor 1 and compound injection nozzle 7 for introducing chlorine, ammonia and nitrogen into reaction zone 5. Compound nozzle 7 comprises chlorine injection nozzle 8, surrounded by ammonia injection nozzle. Nitrogen gas is introduced into the chlorine delivery line via mixing area 10. Reaction-zone 5 comprisies an expansion region which projects radially with respect to compound nozzle 7, which expansion region is configured with respect to the reagent flow rates to provide a laminar flow region for the reaction to take place.

Chlorine, ammonia and nitrogen are supplied to reagent supply zone 2 from reservoirs 11, 12 and 13 via flow controllers 14, 15 and 16.

Chloramine gas is recovered from product recovery zone 3 in line 6 and solid ammonium chloride is recovered in line 17.

The process of the invention will now be more particularly described with reference to the following examples.

### EXAMPLE 1

A reactor system was built containing the following elements. A gas manifold was constructed of 6 mm OD 316 stainless steel tubing and Swagelok compression fittings. The manifold incorporated ammonia, chlorine and nitrogen mass flow controllers (supplied by Bronkhorst) and Swagelok ball valves, which were used to isolate the flow controllers and to direct nitrogen through the ammonia and chlorine flow controllers during purging operations (see FIG. 1). Mixing of the gases was achieved using an annular mixer comprising a 6 mm OD inner tube and a 10 mm OD outer tube to give a 1 mm annulus. Chlorine and nitrogen were mixed using a 6 mm Swagelok tee connected to the inner tube. Ammonia was fed into the outer tube via a 10 mm Swagelok tee. The mixer was configured such that the inner tube protruded from the outer tube by 5 mm, this prevented blocking inside the annulus by maintaining a high concentration of ammonia at the chlorine exit. The nitrogen stream was equipped with an in-line heat exchanger and thermocouple. (see FIG. 1). The outer tube of the annular mixer was inserted into the top of a 200 L volume, 565 mm diameter cylindrical gravitational separator constructed of mild steel. The mixer was centrally positioned to maximise the distance from the separator walls. A chloramine sample-point, pressure release system and chloramine gas off take were positioned in each quadrant 70 mm from the wall. The separator was also equipped with a differential pressure sensor, which acted as an alarm to warn of any pressure build-up. A wall-bound thermocouple was used to measure the separator temperature. The product vapour stream was cooled in-situ using the nitrogen carrier/diluent gas and excess ammonia. Standard flow rates for this reactor configuration were:
Chlorine: 8.0 g/min
Ammonia: 8.3 g/min
Nitrogen: 20 g/min

The reactor was started by flowing nitrogen through all three mass flow controllers by opening valves V4 and V5. When the mass flow controllers indicated stable flow the ammonia feed was opened and valve V4 closed. The gravitational separator was filled with nitrogen and ammonia for five minutes before starting the chlorine feed and closing valve V5. This start-up procedure ensured an excess of ammonia was present to prevent formation of dichloramine or ammonium trichloride. With the in-line nitrogen heater turned off the gravitational separator reached a steady state temperature of between 65° C. to 70° C. and efficiently removed >90% of the generated ammonium chloride as a free flowing powder.

### EXAMPLE 2

The annular mixer described in Example 1 was inserted centrally into the top of a 40L volume, 350 mm diameter cylindrical gravitational separator constructed of high-density polyethylene. A chloramine sample point, pressure release system and chloramine gas off take were positioned in each quadrant 40 mm from the wall. The separator was also equipped with a differential pressure sensor, which acted as an alarm to warn of any pressure build-up. A wall-bound thermocouple was used to measure the separator temperature. The product vapour stream was cooled in-situ using the nitrogen carries/diluent gas and excess ammonia. Standard flow rates for this reactor configuration were:
Chlorine: 1.0 g/min
Ammonia: 2.7 g/min
Nitrogen: 5.0 g/min

The same gas manifold and start-up procedure was used as described in Example 1. With the in-line nitrogen heater turned off the gravitational separator reached a steady state temperature of between 35° C. to 40° C. and efficiently removed >90% of the generated ammonium chloride as a free flowing powder.

1. A process for the production of chloramine comprising supplying a first reagent stream comprising chlorine gas and a second reagent stream comprising ammonia gas to a reaction zone maintained at a temperature of less than 275° C. and configured to allow expansion of the first and second reagent streams in the reaction zone to an extent sufficient to generate chloramine as a gas and ammonium chloride as a free falling solid.

2. A process according to claim 1 wherein the reaction zone is configured such that at least about 90% of the generated ammonium chloride is formed at least about 10 mm away from any wall of the reaction zone.

3. A process according to claim 1 wherein the reaction zone is bounded towards its top by a reagent supply zone, from which the first and second reagent streams are supplied to the reaction zone.

4. A process according to claim 3 wherein the reaction zone is bounded towards its bottom by a solids recovery zone, from which solid ammonium chloride is recovered or collected.

5. A process according to claim 4 wherein the reaction zone is bounded by side walls or a continuous side wall extending between the reagent supply zone region and the product recovery zone.

6. A process according to claim 5 wherein the side walls or the continuous side wall bounding the reaction zone circumscribe an expansion region into which chlorine and ammonia from the reagent streams expand before reacting to form chloramine and ammonium chloride.

7. A process according to claim 6 wherein the expansion region is configured to provide a laminar flow region for the reaction between chlorine and ammonia to take place.

8. A process according to claim 6 wherein the expansion region is of a size sufficient to allow at least 60% of the chlorine gas to react before contacting the side walls or the continuous side wall.

9. A process for the production of chloramine comprising:
providing chlorine gas and ammonia gas to a reaction zone maintained under conditions effective for chlorination of ammonia, and at a temperature of less than 275° C., the reaction zone having a laminar flow region for receiving the chlorine gas and the ammonia gas supplied thereto, whereby chloramine is produced.

10. A process according to claim 9 wherein the laminar flow region is bounded by a Reynolds Number of not more than 2000.

11. A chemical reactor suitable for the production of chloramine, the reactor comprising:
a reagent supply zone above a product recovery zone, and a reaction zone bounded by side walls or one continuous side wall extending between the reagent supply zone and the product recovery zone, the reagent supply zone comprising means for supplying, separately, chlorine reagent gas and ammonia reagent gas to the reaction zone, at least one of the supply means being configured to direct a reagent gas into a laminar flow region of the reaction zone.

12. A reactor according to claim 11 wherein the reaction zone is configured to be maintained at a temperature of less than 275° C. and configured to allow expansion of the reagent gas in the reaction zone to an extent sufficient to generate chloramine as a gas and ammonium chloride as a free falling solid.

13. A reactor according to claim 11, wherein the supply means comprises at least one injection nozzle.
